(19) United States
(12) Patent Application Publication
(10) Pub. No.: US 2015/0206248 A1
(43) Pub. Date: Jul. 23, 2015

(54) APPARATUS AND METHOD FOR SUPPLYING OPTIMIZED INSURANCE QUOTES

(71) Applicant: Esurance Insurance Services, Inc., San Francisco, CA (US)

(72) Inventors: Tolithia Gay KORNWEIBEL, San Francisco, CA (US); Darren Albert Howard, Studio City, CA (US); Ryan Daniel Hartman, Arlington, VA (US); John Christian Swigart, McLean, VA (US)

(73) Assignee: Esurance Insurance Services, Inc., San Francisco, CA (US)

(21) Appl. No.: 14/161,586

(22) Filed: Jan. 22, 2014

Related U.S. Application Data
(63) Continuation-in-part of application No. 13/601,740, filed on Aug. 31, 2012.
(60) Provisional application No. 61/530,325, filed on Sep. 1, 2011.

(51) Int. Cl. G06Q 40/08

(52) U.S. Cl. CPC G06Q 40/08

(57) ABSTRACT

Methods for identifying insurance product offerings from different insurers to present to a user are provided. In one aspect, a method includes receiving user information for a user seeking an insurance product offering, and identifying, based on the user information, at least one insurance product offering from at least one of the plurality of insurers to provide for display in a prioritized insurance policy presentation. The method also includes providing the identification of the at least one insurance product offering from the at least one of the plurality of insurers for display in the prioritized insurance policy presentation. Systems and machine-readable media are also provided.

### CROSS-REFERENCE TO RELATED APPLICATIONS

The present application claims the benefit of priority under 35 U.S.C. §120 as a continuation-in-part from U.S. patent application Ser. No. 13/601,740 entitled “Apparatus And Method For Supplying Optimized Insurance Quotes”, filed on Aug. 31, 2012, which claims priority to U.S. Provisional Patent Application 61/530,325, filed Sep. 1, 2011, entitled “Variable Quote Treatments”, the contents of which are incorporated herein by reference.

### BACKGROUND

1. Field

This present disclosure relates generally to computer networks configured to supply insurance services. More particularly, the present disclosure relates to techniques for supplying optimized insurance quotes.

2. Description of the Related Art

An insurer with little or no information about a user seeking an insurance product offering will supply a quote for the user assuming a relatively high risk factor associated with the user. Incremental additional knowledge about the user may allow the insurer to offer a more competitive quote, which may lead to additional business. If the additional knowledge about the user indicates the user is unlikely to accept any competitive quote offered by the insurer, then the insurer is unlikely to benefit from the user even though the user is seeking to accept an offer for insurance from an insurer.

### SUMMARY

According to certain embodiments of the present disclosure, a system for identifying insurance product offerings from different insurers to present to a user is provided. The system includes a memory that includes instructions, and a processor. The processor is configured to execute the instructions to receive user information for a user seeking an insurance product offering, and identify, based on the user information, at least one insurance product offering from at least one of a plurality of insurers to provide for display in a prioritized insurance policy presentation. The processor is also configured to provide the identification of the at least one insurance product offering from the at least one of the plurality of insurers for display in the prioritized insurance policy presentation.

According to certain embodiments of the present disclosure, a method for identifying insurance product offerings from different insurers to present to a user is provided. The method includes receiving user information for a user seeking an insurance product offering, and identifying, based on the user information, at least one insurance product offering from at least one of the plurality of insurers to provide for display in a prioritized insurance policy presentation. The method also includes providing the identification of the at least one insurance product offering from the at least one of the plurality of insurers for display in the prioritized insurance policy presentation.

According to certain embodiments of the present disclosure, a machine-readable storage medium that includes machine-readable instructions for causing a processor to execute a method for identifying insurance product offerings from different insurers to present to a user is provided. The method includes receiving user information for a user seeking an insurance product offering, and identifying, based on the user information, at least one insurance product offering from at least one of the plurality of insurers to provide for display in a prioritized insurance policy presentation. The method also includes providing the identification of the at least one insurance product offering from the at least one of the plurality of insurers for display in the prioritized insurance policy presentation.

### BRIEF DESCRIPTION OF THE DRAWINGS

FIGS. 1A and 1B illustrate a system utilized in accordance with certain aspects of the disclosure.

FIG. 2A illustrates processing operations associated with certain aspects of the disclosure.

FIGS. 2B and 2C illustrate example prioritized insurance policy presentations supplied to a user.

FIG. 3 illustrates additional processing operations associated with certain aspects of the disclosure.

FIG. 4 is a block diagram illustrating example servers from the architecture of FIG. 1B according to certain aspects of the disclosure.

FIG. 5 illustrates processing operations that may be used to prioritize policies for inclusion in a prioritized insurance policy presentation supplied to a user using the example servers of FIG. 4.

FIG. 6 is a block diagram illustrating an example computer system with which the servers and client devices of FIGS. 1A and 1B can be implemented.

Like reference numerals refer to corresponding parts throughout the several views of the drawings.

### DETAILED DESCRIPTION

In the following detailed description, numerous specific details are set forth to provide a full understanding of the present disclosure. It will be apparent, however, to one ordinarily skilled in the art that the embodiments of the present disclosure may be practiced without some of these specific details. In other instances, well-known structures and techniques have not been shown in detail so as not to obscure the disclosure.

Although many examples provided herein describe a user's (i.e., customer) information being stored in memory and/or shared, each user may be provided with an opportunity to grant explicit permission for such user information to be stored. The explicit permission may be granted using privacy controls integrated into the disclosed system. If requested user information includes demographic information, then the demographic information is aggregated on a group basis and not by individual user. Each user may be provided notice that such user information will be stored, and each user may at any time end having the user information stored, and may delete the stored user information. The stored user information may be encrypted to protect user security. In many examples, the user information does not include and/or share the specific identification of the user (e.g., the user's name) unless otherwise specifically provided or directed by the user.

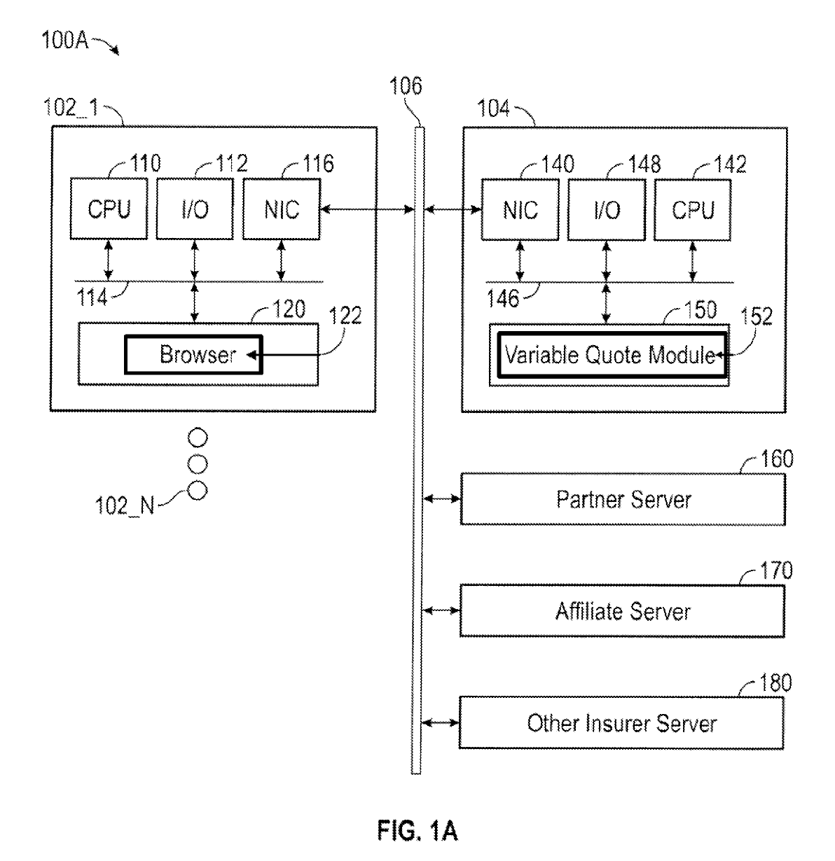

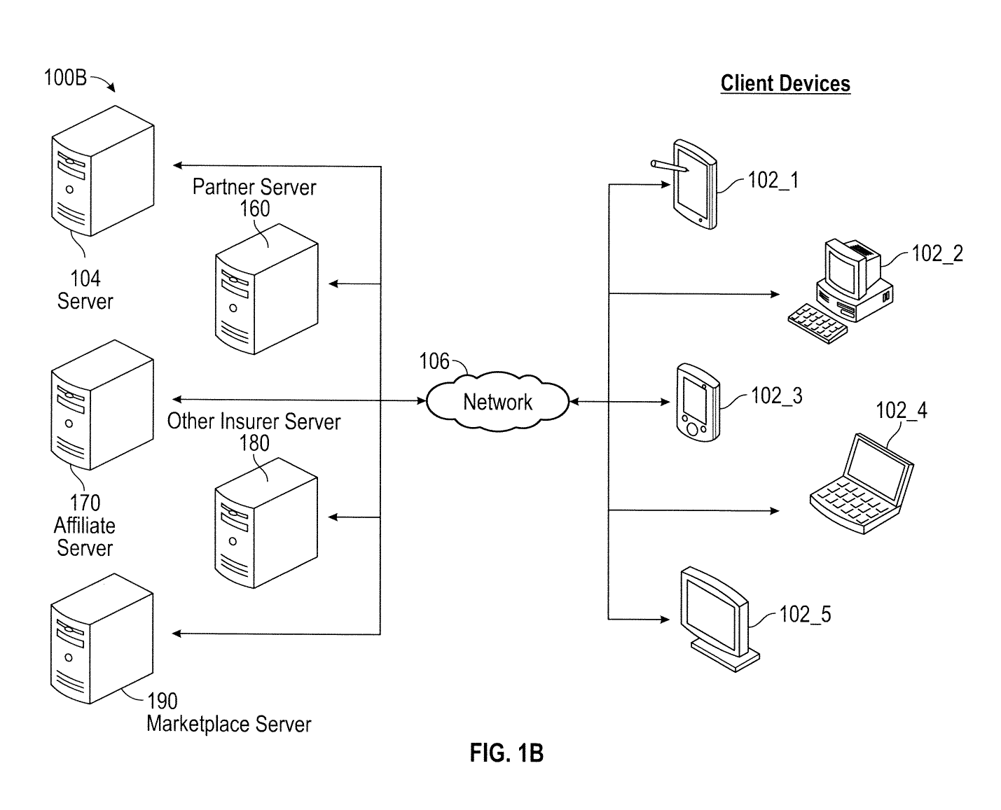

Turning now to the drawings, FIG. 1A illustrates a system 100A configured in accordance with certain aspects of the disclosure. The system 100A includes a set of client devices 102_1 through 102_N. Each client device 102 is a computation device, such as a personal computer, a tablet computer or a smartphone.

Each client device 102 includes standard components, such as a central processing unit (CPU) 110 and input/output devices 112 connected via a bus 114. The input/output devices 112 may include a keyboard, touch screen, mouse, track ball and the like. A network interface circuit (NIC) 116 is also connected to the bus 114. The network interface circuit 116 provides connectivity to any wired or wireless network 106. A memory 120 is also connected to the bus 114. The memory 120 stores executable modules, such as a browser 122.

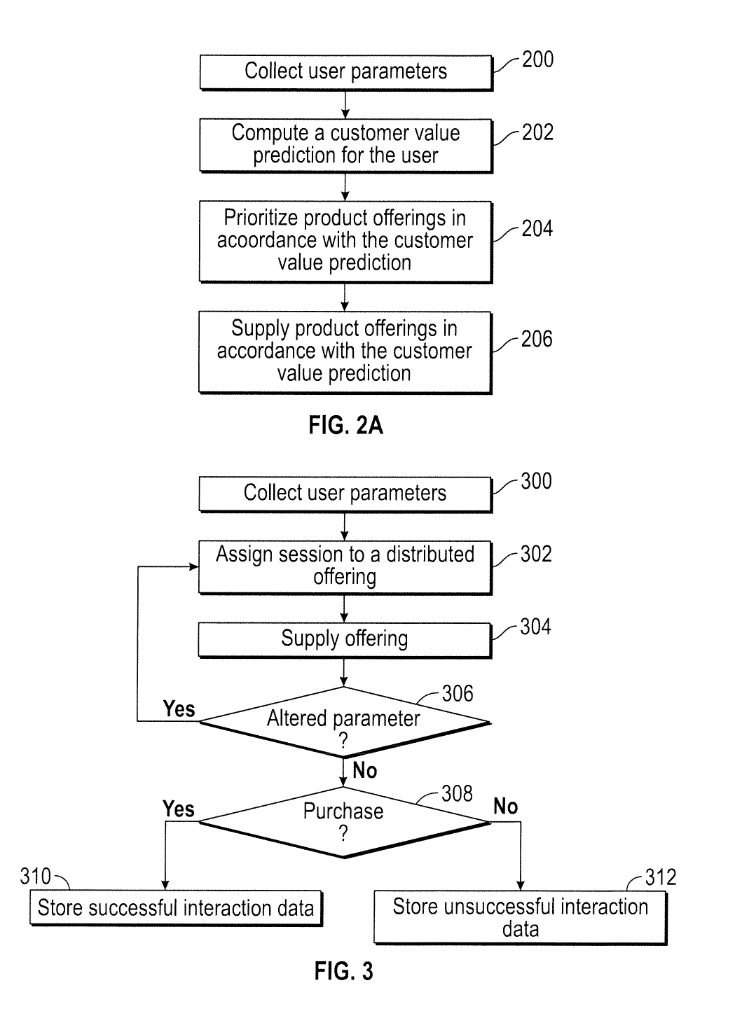

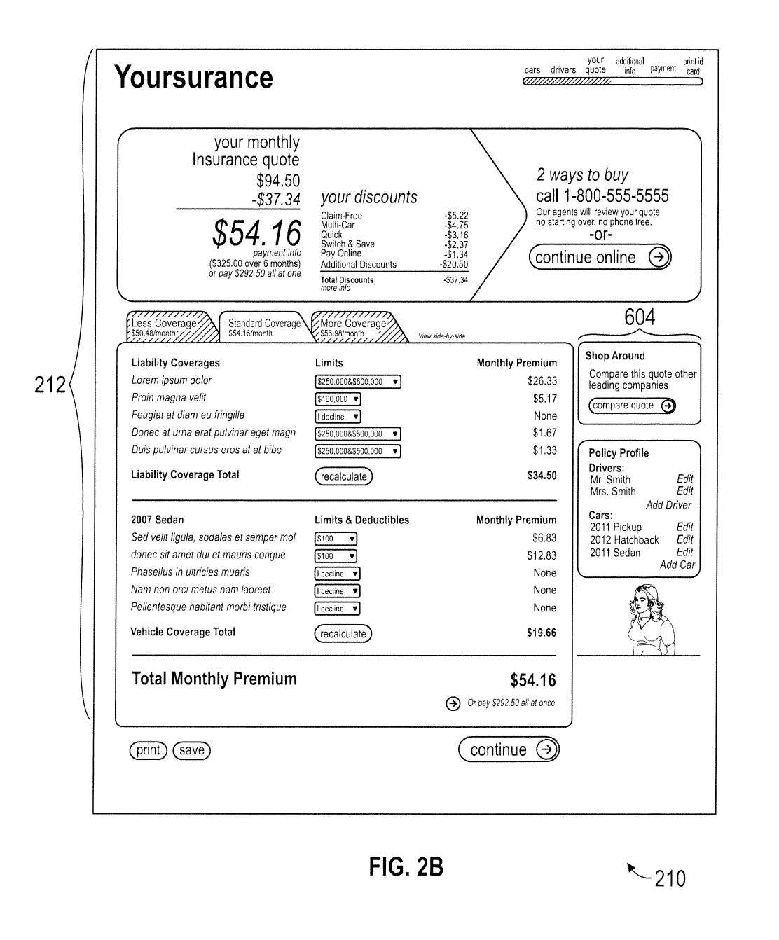

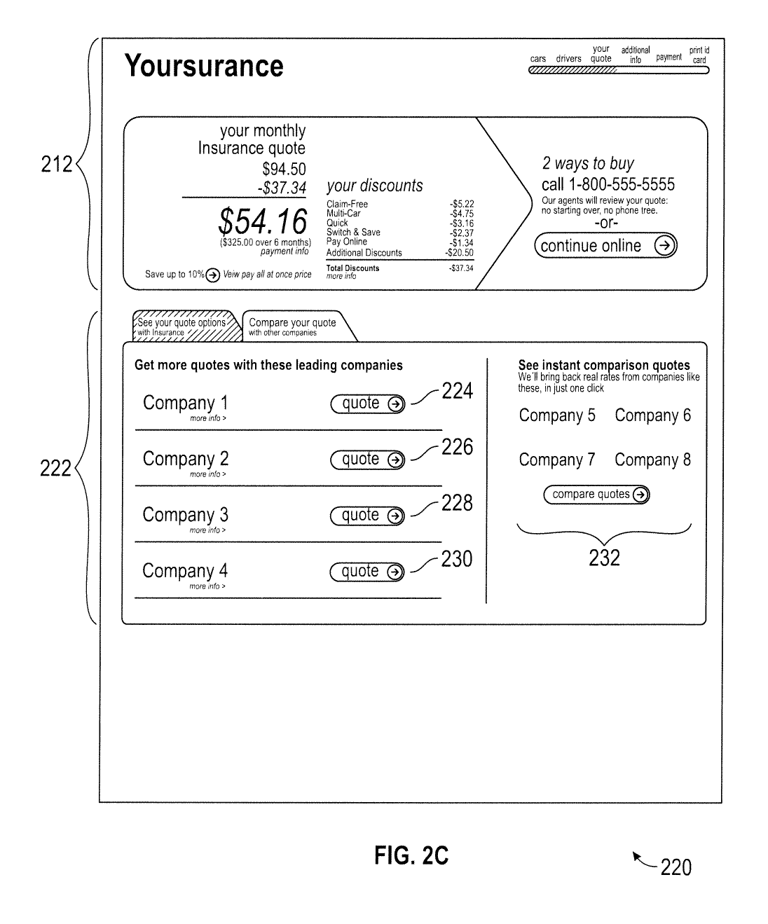

A server 104 is also connected to the network 106. In certain aspects, the operator of server 104 may be an insurance provider. The server 104 includes standard components, such as a central processing unit 142, input/output devices 148 and a network interface circuit 140 connected via a bus 146. A memory 150 is also connected to the bus 146. The memory 150 includes executable instructions to implement operations of certain aspects of the disclosure. In one embodiment, a variable quote module 152 is stored in memory 150. The variable quote module 152 includes executable instructions to implement operations disclosed in connection with FIGS. 2 and 3.

The server 104 may operate in conjunction with one or more additional servers. In one embodiment, the server 104 communicates with a partner server 160 over network 106. The partner server 160 provides quote information to the server 104. The term partner server references a business partnership that exists between the operator of server 104 and the operator of partner server 160. Therefore, the quotes provided by the partner server 160 may be subject to some revenue sharing provision or other economic arrangement. The partner server 160 may be implemented as a web service or any other networked service.

The server 104 may also communicate with an affiliate server 170. The affiliate server 170 provides quote information to the server 104. The term affiliate server references some type of affiliation that exists between the operator of server 104 and the operator of affiliate server 170. Therefore, the quotes provided by the affiliate server 170 may be subject to some type of commission fee paid to the operator of server 104. The affiliate server 170 may be implemented as a web service or any other networked service.

Another insured server 180 may also be connected to server 104 through network 106. Insured server 180 provides quotes to server 104, but there is no pre-existing economic relationship between the operator of the server 104 and the insured server 180. The server 180 may be implemented as a web service or any other networked service.

Since various economic relationships may exist between the operator of server 104, the operator of partner server 160, the operator of affiliate server 170 and another insurer server 180, it may be desirable to present insurance quotes (e.g., insurance services or insurance products) to users of clients 102_1, 102_2, 102_3, 102_4, and 102 that are optimized in accordance with these economic relationships.

FIG. 1B illustrates another embodiment of a system 100B configured in accordance with the disclosure. The system 100B includes servers 104, 160, 170, 180, and 190 and clients 102_1, 102_2, 102_3, 102_4, and 102_5 connected over a network 106.

In certain aspects discussed above, the operator of server 104 described above may be an insurance provider (or “referring insurer”) or otherwise be associated with an insurance provider providing insurance product offerings to users (or “customers”). In certain aspects, however, the operator of the server 104 is not an insurance provider, but may still provide information on insurance product offerings to users. As discussed herein, an insurance product offering can include an insurance service, an insurance product, or a quote for an insurance service or product. The insurance product offering may be a hyperlink to more information the insurance service or insurance product, an advertisement for the insurance service or insurance product, information on the insurance service or insurance product, or a right or opportunity to display a hyperlink, advertisement, or information for the insurance service or insurance product. The server 104, like the partner server 160, affiliate server 170, and other insurer server 180 described above, is connected to the network 106. Also connected to the network 106 is a marketplace server 190.

The marketplace server 190 is configured to communicate with the server 104 to receive information for a user seeking an insurance product offering, collect any bids from the partner server 160, affiliate server 170, and other insurer server 180 to display an insurance product offering to the user, and identify any qualifying bid(s) and related insurance product offering(s) to the server 104. The qualifying bid may be selected based on, for example, a configuration combining the highest relevance of a bid to the user, and the highest profit of a bid for the referring insurer. The insurance product offering(s) may then be provided for display to the user in a prioritized insurance policy presentation. In certain aspects, a lead (i.e., for the user) may instead be provided to the insurer associated with the qualifying bid(s) so that, for example, the user is directed to a server (e.g., server 104, partner server 160, affiliate server 170, or other insurer server 180) associated with that insurer. The marketplace server 190 can be any device having an appropriate processor, memory, and communications capability for hosting a marketplace application for collecting bidding information from insurers and determining qualifying bids associated with insurance product offerings of the insurers to provide for display with a prioritized insurance policy presentation. In certain aspects discussed herein, a prioritized insurance policy presentation is a display of insurance product offerings from one or many insurers that optimizes revenue for at least one of the insurers by presenting insurance products and offerings that are tailored to different types of users (i.e., “quoter segments”).

The clients 102_1, 102_2, 102_3, 102_4, 102_5 . . . 102_{—}n to which the servers 104, 160, 170, 180, and 190 are connected over the network 106 can be, for example, desktop computers, mobile computers, tablet computers (e.g., including e-book readers), mobile devices (e.g., a smartphone or PDA), set top boxes (e.g., for a television), wearable computers (e.g., smart glasses) video game consoles, or any other devices having appropriate processor, memory, and communications capabilities for receiving and displaying a prioritized insurance policy presentation. The network 106 can include, for example, any one or more of a personal area network (PAN), a local area network (LAN), a campus area network (CAN), a metropolitan area network (MAN), a wide area network (WAN), a broadband network (BBN), the Internet, and the like. Further, the network 106 can include, but is not limited to, any one or more of the following network topologies, including a bus network, a star network, a ring network, a mesh network, a star-bus network, tree or hierarchical network, and the like.

FIG. 2 illustrates processing operations associated with certain aspects of the disclosure. Initially, customer value parameters are collected 200. For example, a user using a client device 102 may access server 104 to retrieve a web page. The web page may include prompts to receive parameters for a user (or “user information”). For example, a parameter may be the zip code associated with the user of the client device 102. Another gathered parameter may include item type (e.g., vehicle type), user name, user address, an existing policy number or other parameter.

Other parameters may be automatically collected. For example, the parameter may be a referral source indicator. One type or referral source indicator may be used if the user directly accessed the web page of the insurer operating server 104. Another type of referral source indicator may be used if the user arrived at server 104 via a click-through from another web site. Still another type of referral source indicator may be used if the user arrived at server 104 via a click-through from a search engine.

A customer value prediction is then computed 202. The customer value prediction may be derived from a customer value prediction model. The customer value prediction model may rely upon any number of factors. The factors may be weighted or unweighted. The factors may be individually utilized or may be combined in any number of ways.

For example, as one factor, the customer value prediction model may rely upon the received zip code. In one embodiment, the variable quote module 152 includes executable instructions to retrieve a zip code score for the zip code. The zip code score may be based upon demographics associated with the zip code. The demographics may include data based upon average age, average income and/or home ownership percentage associated with the zip code. One or more of these factors may be weighted and/or combined to generate the zip code score.

As another factor, the customer value prediction model may also rely upon the referral source indicator. A referral source score for a referral source indicator may be retrieved. The referral source score may be based upon conversion data associated with the referral source. For example, a relatively high referral source score may be assigned for an interaction initiated at the server 104. A lower score may be assigned for a click-through from another web site. A still lower score may be assigned for a click-through from a search engine. Any number of referral source scoring criteria may be used in accordance with certain aspects of the disclosure.

As an additional factor, the customer value prediction model may also rely upon a quote-to-purchase conversion rate. The quote-to-purchase conversion rate may be based upon prior activity of the particular user, prior activity of similar users or related criteria.

As yet another factor, the customer value prediction model may also rely upon a policy value. For example, a longer term policy for a more expensive insured entity may result in a higher customer value prediction than a shorter term policy for a less expensive insured entity.

As another factor, the customer value prediction model relies upon stored successful interaction data and stored unsuccessful interaction data. This data informs the quote-to-purchase conversion rate and other factors that may be used in the customer value prediction model.

A quote value for the customer value prediction is determined based any combination of the above-referenced factors or other additional factors. The quote value may be assigned a dollar amount and/or a grade (e.g., a letter from “A” to “X”).

The next operation of FIG. 2 is to prioritize policies in accordance with the customer value prediction 204. Any number of prioritization schemes may be used. For example, in certain aspects a user with a particularly high customer value prediction may receive insurance product offerings from the operator of server 104. In certain other aspects, a user will receive at least one insurance product offering from the operator of the server 104 regardless of the user's customer value prediction. An insurance product offering has associated premium levels, deductibles, policy limits and policy exclusions. Naturally, any number of insurance product offerings may be generated based upon the foregoing factors and any number of additional or alternative factors.

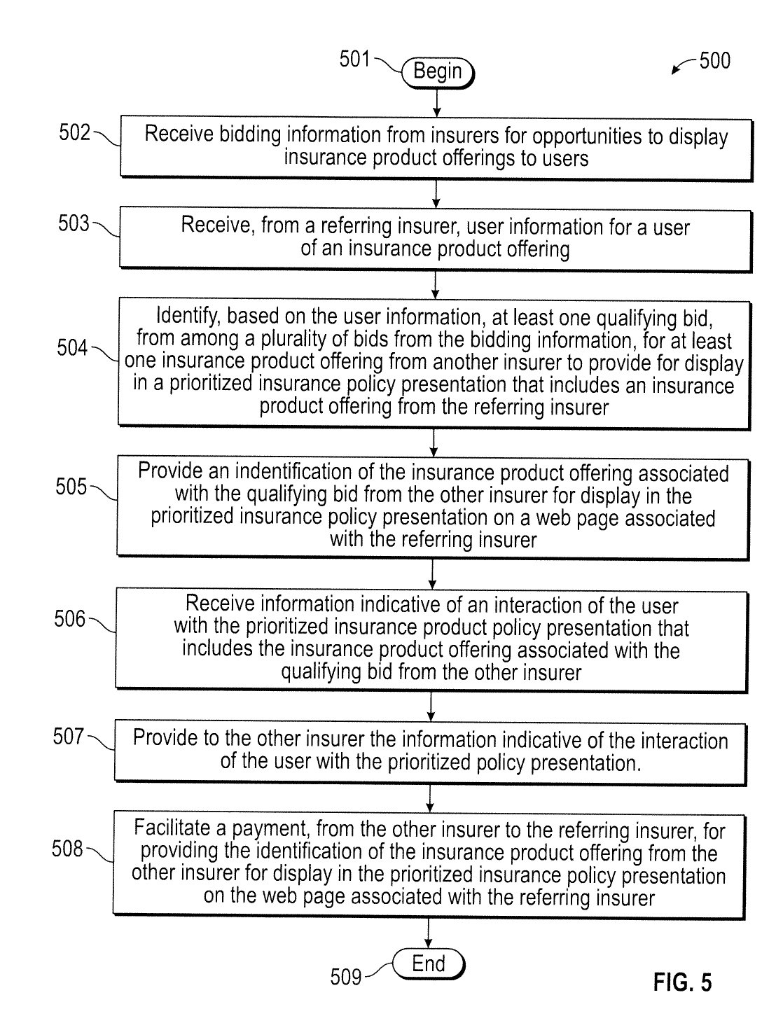

A user with a lower customer value prediction may receive an insurance product offering from a partner insurance provider, such as the operator of partner server 160. Such an insurance product offering may be supplied by the server 104 or may be supplied directly from the partner server 160. A user with a less desirable customer value prediction may receive an insurance product offering from an affiliate insurance provider, such as the operator of affiliate server 170 or from another insurer, such as the operator of insurer server 180. Such offerings may be alternately supplied by the server 104 or directly from servers 170 or 180. FIG. 5, discussed in further detail below, illustrates processing operations that may be used to prioritize policies that are included in the prioritized insurance policy presentation that is supplied to the user in operation 206.

The prioritized insurance policy presentation is then supplied to the user in operation 206. The prioritized insurance policy presentation includes one or more insurance product offerings, which may be presented in a single web page, a sequence of web pages, an email, a mobile application, or an advertisement. The quote value (e.g., letter grade) associated with the customer value prediction may determine the version of the prioritized insurance policy presentation provided to the user, with different quote values indicative of different versions of the prioritized insurance policy presentation. The version of the prioritized insurance policy presentation may also be influenced by considerations in addition to the quote value, such as business decisions. For example, if a certain quote value associated with the letter grade “E” would normally dictate a first version for the prioritized insurance policy presentation, there may be an additional time-limited rule that for a certain period of time the prioritized insurance policy presentation should include certain insurance product offerings from partner insurance providers that are displayed more prominently. Accordingly, the version of the prioritized insurance policy presentation may be based on both quote value and business considerations.

FIG. 2B illustrates an example prioritized insurance policy presentation 210 supplied to a user having a particularly high customer value prediction. The example prioritized insurance policy presentation 210 prominently displays insurance product offerings 212 from the operator of server 104 because of the high customer value prediction indicating the user's likelihood to purchase an insurance product offering from the operator of server 104, or the user's estimated lifetime value to an insurer. The prioritized insurance policy presentation 210 also includes an interface 604 (e.g., hyperlinks) for the user to seek insurance product offerings from other insurers, however, the interface 604 is not prominently displayed due to the user's particularly high customer value prediction.

FIG. 2C illustrates an example prioritized insurance policy presentation 220 supplied to a user having a lower customer value prediction. The example prioritized insurance policy presentation 220 includes insurance product offerings 222 from affiliate insurance providers, Company 1 224, Company 2 226, Company 3 228, and Company 4 230, which may be operators of one or many affiliate servers 170. The insurance product offerings 222 from affiliate insurance providers are prominently displayed with an insurance product offering 212 of the operator of server 104. Additionally, the example prioritized insurance policy presentation 220 includes insurance product offerings 232 from partner insurance providers Company 5, Company 6, Company 7, and Company 8, which are less prominently displayed than the insurance product offerings 222 from affiliate insurance providers due, for example, to a stronger relationship between the affiliate insurance providers with the operator of server 104 than between the partner insurance providers with the operator of server 104. In certain aspects discussed in further detail below, the insurance product offerings 232 from partner insurance providers Company 5, Company 6, Company 7, and Company 8, may be displayed less prominently than the insurance product offerings 222 from affiliate insurance providers due, for example, to lesser value bids from the partner insurance providers than the affiliate insurance providers, predicted relevance of insurance product offerings to the user, expected profit to an insurer, or the user information 154 of the user.

FIG. 3 illustrates processing operations that may be used to create and update a customer value prediction model. Initially, user parameters are collected 300. In particular, user parameters are collected during a communication session between a client device 102 and server 104. The communication session may be randomly assigned a distributed insurance product offering, where the distributed insurance product offering is one of a number of insurance product offerings assigned on a random basis. For example, a set of ten insurance product offerings may be formulated with different insurance products from a single insurer or multiple insurers. The product offerings are formulated to help differentiate user interactions and thereby improve the customer value prediction model.

A product offering is then supplied to the user 304. If a parameter is altered (e.g., additional user information is provided), then the altered parameter is used to effectively create a new session and return controls to operation 302.

The session is monitored for a purchase 308. If a purchase occurs, then successful interaction data is stored 310. Otherwise, unsuccessful interaction data is stored 312. The interaction data may include all of the data associated with the communication session. This interaction data is used to augment the customer value prediction model.

Those skilled in the art will appreciate that any number of customer value prediction models based upon any number of criteria may be used in accordance with certain aspects of the disclosure. The customer value prediction may also be used to present insurance product offerings in any number of manners. In some instances, it may be desirable to optimize insurance product offerings to supply a user with the lowest possible quote. In other instances it may be desirable to optimize insurance product offerings to achieve a high conversion rate for the operator of server 104 or to achieve a high conversion rate for the operator of the partner server 160 or the affiliate server 170. Any number of optimization schemes may be utilized in accordance with certain aspects of the disclosure.

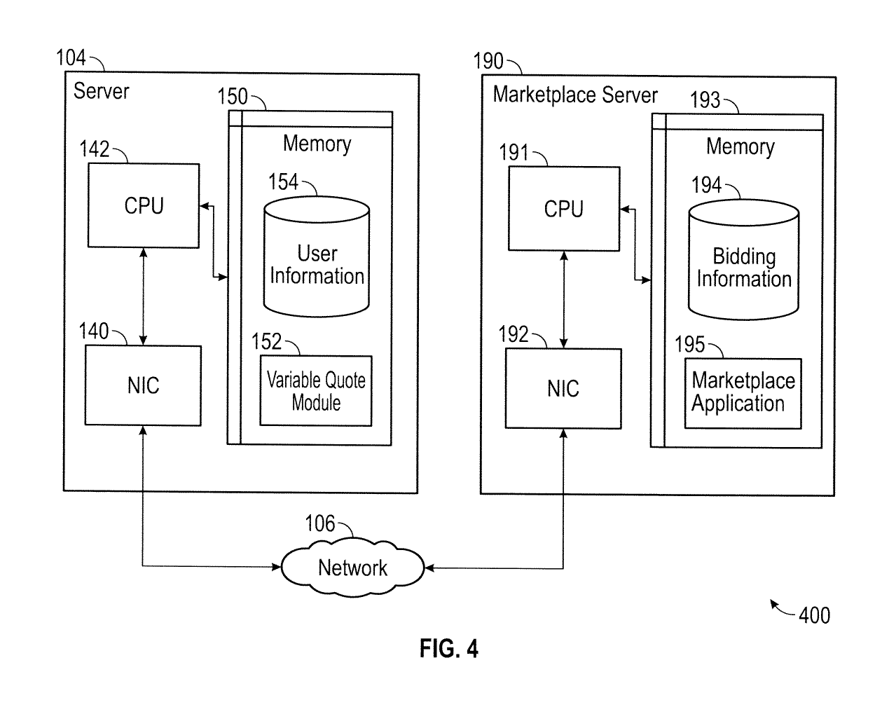

FIG. 4 is a block diagram 400 illustrating an example server 104 and marketplace server 190 from the architecture of FIG. 1B according to certain aspects of the disclosure. In certain aspects, the insurer associated with the server 104 may seek to include insurance product offerings from other insurance providers as discussed above when providing the prioritized insurance policy presentation supplied to the user in operation 206. Alternatively, the insurer associated with the server 104 may seek to provide a lead for the user to other insurance providers instead of providing a prioritized insurance policy presentation to the user. Such functionality may be provided by the marketplace server 190. The marketplace server 190 may be operated by the same operator of the server 104, or may be operated by a different operator than the operator of the server 104. For example, if an insurer operates the server 104, the insurer may also operate the marketplace server 190. Additionally, the marketplace server 190 and the server 104 may be the same server. In such instances, although the marketplace server 190 is illustrated in the block diagram 400 and in FIG. 1B as a separate server than the server 104, the functionality of the marketplace server 190 may be included in or otherwise functional on the server 104. As another example, a third party may operate the marketplace server 190, and insurers that operate the server 104, the partner server 160, the affiliate server 170, and the other insurance server 180 may connect to the marketplace server 190 over the network 106 in order to provide opportunities to include insurance product offerings from other insurance providers when providing a prioritized insurance policy presentation to the user.

An operator associated with the server 104, which may be an insurer (i.e., the referring insurer), may seek to include insurance product offerings from other insurance providers for display to a user when, for example, the user has a lower or less desirable customer value prediction to the referring insurer. Other insurance providers whose insurance product offerings are included in the prioritized policy presentation may pay or otherwise provide a reward (e.g., reciprocation of including insurance product offerings in prioritized policy presentations) to the referring insurer for including the other insurance providers' insurance product offerings in the prioritized insurance policy presentation provided by the referring insurer. The inclusion of insurance product offerings from other insurance providers can be advantageous where, for example, the customer value prediction indicates the user is less likely to buy from the referring insurer associated, such that the referring insurer finds it more beneficial to receive payment from another insurance provider for providing the other insurance provider's insurance product offering to the user rather than providing just the referring insurer's insurance product offering to the user that is not likely to select the referring insurer's insurance product offering.

When the referring insurer identities a user as having a lower or less desirable customer value prediction, the referring insurer can provide a lead on the user to the marketplace server 190 for the other insurers (e.g., insurers that operate the partner server 160, affiliate server 170, and other insurance server 180) to bid on. In certain aspects, the referring insurer provides a lead on the user to the marketplace server 190 for the other insurers to bid on regardless of the user's customer value prediction. One or many qualifying bids associated with insurance product offerings from the other insurers that are identified by marketplace server 190 are provided to the referring insurer associated with server 104 so that the qualifying insurance product offerings from the other insurers can be included in a prioritized insurance policy presentation provided to the user by the server 104 in place of or in addition to any insurance product offerings by the referring insurer. Alternatively, the qualifying bid associated with an insurance product offering of another insurer (e.g., insurers that operate the partner server 160, affiliate server 170, or other insurance server 180) that is identified by the marketplace server 190 can be provided to the referring insurer associated with the server 104, and the lead for the user may be provided to the other insurer so that the user is directed to (i.e., “user traffic”) the other insurer for an insurance product offering from the other insurer. Accordingly, the marketplace server 190 provides a digital inventory exchange where insurers purchase leads from referring insurers, but can also sell traffic, through the quote process, in a manner which has been optimized using a customer value prediction model.

The server 104 and the marketplace server 190 are connected over the network 106 via respective network interface circuits 140 and 192. The network interface circuits 140 and 192 are configured to interface with the network 106 to send and receive information, such as data, requests, responses, and commands to other devices on network 106. The network interface circuits 140 and 192 can be, for example, modems or Ethernet cards.

The marketplace server 190 includes a central processing unit 191, the network interface circuit 140, and a memory 192 that includes bidding information 194 and a marketplace application 195. The central processing unit 191 of the marketplace server 190 is configured to execute instructions, such as instructions physically coded into the central processing unit 191, instructions received from software (e.g., marketplace application 195) in memory 240, or a combination of both, to identify insurance product offerings from different insurers to present to a user. For example, the central processing unit 191 of the marketplace server 190 executes instructions to receive user information 154 for a user seeking an insurance product offering. The user information 154 can be received, for example, from a memory 150 of the server 104 operated by an insurer (i.e., the referring insurer), the user being a lead of the referring insurer visiting a website of the referring insurer hosted by the server 104 and seeking to purchase an insurance product offering from the referring insurer. The user information 154 is provided to the marketplace server 190 by the central processing unit 142 of the server 104 over the network 106 using the network interface circuits 140 and 192 of the server 104 and the marketplace server 190, respectively.

The user information 154 can include, for example, a zip code, credit tier, premium amount, geographic location, a reason for seeking insurance, a number of items (e.g., vehicles) to be insured, a previous insurer, education level, age, bodily injury limit, age of an item (e.g., vehicle), number of previous insurable incidents, coverage package, type of residence, marital status, day of week an insurance product offering was requested, prior insurance information, amount of time lapse since the insurance product offering was requested, a number of drivers to be insured, or gender of the user. In certain aspects, a user must provide authorization for such user information 154 to be obtained by the server 104 and/or shared with the marketplace server 190.

The central processing unit 191 of the marketplace server 190 also executes instructions to identify, based on the user information 154, at least one insurance product offering from at least one of a plurality of insurers (e.g., insurers other than the insurer operating the server 104 that received the lead) to provide for display in a prioritized insurance policy presentation. In certain aspects where the user information 154 is received from a server 104 operated by a referring insurer along with a customer value prediction of the user, the central processing unit 191 of the marketplace server 190 may seek to identify insurance product offerings from other insurers (e.g., insurers other than the insurer operating the server 104) when the customer value prediction is less than a threshold value. For example, if the customer value prediction indicates the user is not likely to purchase an insurance product offering from the referring insurer operating the server 104, then the central processing unit 191 of the marketplace server 190 may seek to identify insurance product offerings from other insurers to provide for display in the prioritized insurance policy presentation. In this case, upon receipt of the user information 154 for the user seeking an insurance product offering, the central processing unit 191 is configured to request a bid from at least two of the insurers for an opportunity to display an insurance product offering to the user, and receive a qualifying bid for at least one insurance product offering from at least one of the insurers. The bid request may occur, for example, by the central processing unit 191 evaluating stored bidding information 194 that is provided in advance by other insurers, by requesting “new” bids from other insurers upon receipt of the user information 154 for the user, or a combination of both. For instance, insurers may provide bidding information in advance (e.g., prior to receiving a request for a bid for any specific user) and the bidding information 194 may be stored in memory 193. The advanced bidding information 194 can include, for example, profiles or other parameters indicating amounts each insurer is willing to bid depending on the type of user identified (e.g., using the user information 154). Additionally, or alternatively, upon receipt of any “new” bids, information regarding the received new bids may be stored in as bidding information 194 in the memory 193 of the marketplace server 190, and the central processing unit 191 may then access the bidding information 194 to identify a qualifying bid. In certain aspects, advertisements or other data for displaying an insurance product offering are also received with bids and the data may be stored in the bidding information 194.

In certain aspects, multiple bids may be considered qualifying bids, and the qualifying bids can be from the same or different insurance providers. The qualifying bid may be selected based on, for example, a configuration combining the highest relevance of a bid to the user, and the highest profit of a bid for the referring insurer. For example, the qualifying bid may be selected based on additional or alternative factors, including a predicted relevance of an insurance product offering to a user, expected profit to the insurer operating the server 104, or the user information 154 of the user. The predicted relevance of an insurance product offering to a user can be determined based on predicted click-through rates, call rates, conversion rates, or brand awareness. The expected profit to the referring insurer can be based on, for example, the price of a bid or expected tradeoffs between the referring insurer and the insurer associated with a bid. In certain other aspects, the qualifying bid may be the highest value bid amongst many bids received in response to the request to bid for the opportunity to display the insurance product offering to the user.

Each bid may be based on the user information 154. For example, an insurer may price a bid based on information about the user indicating the user's zip code, credit tier, premium amount, geographic location, a reason for seeking insurance, a number of items to be insured, a previous insurer, education level, age, bodily injury limit, age of an item, number of previous insurable incidents, coverage package, type of residence, marital status, day of week an insurance product offering was requested, prior insurance information, amount of time lapse since the insurance product offering was requested, a number of drivers to be insured, or gender. In instances where the central processing unit 191 of the marketplace server 190 receives a customer value prediction for the user and a version of the customer value prediction may assist insurers with determining bids, that version of the customer value prediction may be provided to insurers as an additional basis by which the insurers can price a bid.

The central processing unit 191 of the marketplace server 190 further executes instructions to provide the identification of the insurance product offering (e.g. associated with the qualifying bid) from another insurer for display in the prioritized insurance policy presentation (e.g., with any insurance product offering of the referring insurer operating server 104). The identification of the insurance product offering from the other insurer displayed in the prioritized insurance policy presentation can include information on the insurance product offering, an advertisement for the insurance product offering, or a link to more information on the insurance product offering from the other insurer. In certain aspects, the lead/traffic for the user can be provided to the other insurer associated the qualifying bid so that the other insurer can provide the insurance product offering associated with the qualifying bid for display to the user using the other insurer's server (e.g., partner server 160, affiliate server 170, or other insurance server 180).

In certain aspects where more than one insurance product offering is identified (e.g., there is more than one qualifying bid), the central processing unit 191 of the marketplace server 190 is configured to prioritize each of the insurance product offerings for display in the prioritized insurance policy presentation based on a value of the associated qualifying bid, a predicted relevance of an insurance product offering to a user, an expected profit to the referring insurer, or the user information 154 of the user. Where the user is identified from a referring insurer (e.g., operating the server 104), the prioritized insurance policy presentation can include an insurance product offering from the referring insurer and the insurance product offering(s) from the other insurer(s) associated with qualifying bid(s). In such instances, the prioritized insurance policy presentation may be provided for display on a web page, email, mobile application, or advertisement associated with the referring insurer.

In certain aspects, central processing unit 191 of the marketplace server 190 further executes instructions to facilitate payments. The payments are from the other insurers (i.e., associated with qualifying bids) to the referring insurer for providing the insurance product offerings (from the other insurers associated with qualifying bids) for display in the prioritized insurance policy presentation on the web page associated with the referring insurer.

Additionally, in certain aspects, after providing the identification of the insurance product offering (e.g., associated with the qualifying bid) from the other insurer for display in the prioritized insurance policy presentation, the central processing unit 191 of the marketplace server 190 is configured to receive information indicative of an interaction of the user with the prioritized insurance policy presentation that includes the identification of the insurance product offering from the other insurer(s) (e.g., interaction data). The information can include, for example, which insurance product offerings were identified, a date and time of delivery of the offering, click-through activity, etc. The central processing unit 191 of the marketplace server 190 is configured to provide to the other insurer the information indicative of the interaction of the user with the prioritized insurance policy presentation. The interaction data can be provided to the other insurer associated with the qualifying bid, but may also be provided to all of the other insurers that submitted bids so that the insurers have information indicative of user interaction that will assist with determining when and how much to bid for future opportunities.

FIG. 5 illustrates processing operations 500 that may be used to prioritize policies for inclusion in a prioritized insurance policy presentation supplied to a user using the example servers 104 and 190 of FIG. 4. Initially, the processing operations 500 proceed from beginning operation 501 when a marketplace server 190 is initialized to operation 502 when bidding information 194 is received (e.g., by the marketplace application 195 of the marketplace server 190) from insurers for opportunities to display insurance product offerings to users. The bidding information 194 can be stored in the memory 193 of the marketplace server 190. User information is received from a referring insurer for a user seeking an insurance product offering in operation 503. For example, user information 154 is received from the server 104 of a referring insurer.

At least one qualifying bid from among a plurality of bids from the bidding information 194 is identified, based on the user information 154, for at least one insurance product offering from another insurer in operation 504. The insurance product offering is to be provided for display in a prioritized insurance policy presentation that includes an insurance product offering from the referring insurer. An identification of the insurance product offering associated with the qualifying bid from the other insurer is provided for display in operation 505 in the prioritized insurance policy presentation on a web page, email, mobile application, or advertisement associated with the referring insurer. FIG. 2C discussed above illustrates an example prioritized insurance policy presentation 220 on a web page associated with a referring insurer in which insurance product offerings 224, 226, 228, 230, and 232 associated with qualifying bids are provided for display with an insurance product offering of the referring insurer 212.

Information indicative of an interaction of the user with the prioritized insurance policy presentation that includes the insurance product offering associated with the qualifying bid from the other insurer is received in operation 506. The information can include, for example, which insurance product offerings the user interacted with (e.g., clicked on) and for how long the user viewed the prioritized insurance policy presentation. The information indicative of the interaction of the user with the prioritized policy presentation is provided to the other insurer in operation 507. A payment from the other insurer to the referring insurer for providing the identification of the insurance product offering from the other insurer for display in the prioritized insurance policy presentation on the web page, email, mobile application, or advertisement associated with the referring insurer is facilitated in operation 508, and the processing operations 500 then end in operation 509.

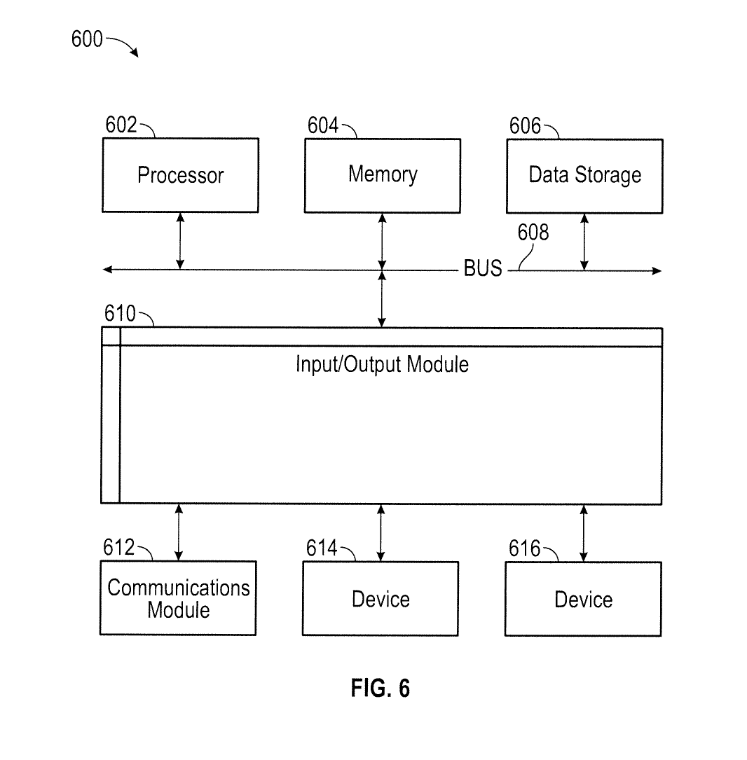

FIG. 6 is a block diagram illustrating an example computer system 600 with which the clients servers of FIGS. 1A and 1B can be implemented. In certain aspects, the computer system 600 may be implemented using hardware or a combination of software and hardware, either in a dedicated server, or integrated into another entity, or distributed across multiple entities.

Computer system 600 (e.g., server 104, partner server 160, affiliate server 170, other insurer server 180, marketplace server 190, and client devices 102_1 . . . 102_N) includes a bus 608 or other communication mechanism for communicating information, and a processor 602 (e.g., CPU 110, 142, and 191) coupled with bus 608 for processing information. By way of example, the computer system 600 may be implemented with one or more processors 602. Processor 602 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 600 can include, in addition to hardware, code that creates an execution environment for the computer program in question, e.g., code that constitutes processor firmware, a protocol stack, a database management system, an operating system, or a combination of one or more of them stored in an included memory 604 (e.g., memory 120, 150, and 193), such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 608 for storing information and instructions to be executed by processor 602. The processor 602 and the memory 604 can be supplemented by, or incorporated in, special purpose logic circuitry.

The instructions may be stored in the memory 604 and implemented in one or more computer program products, i.e., one or more modules of computer program instructions encoded on a computer readable medium for execution by, or to control the operation of, the computer system 600, and according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, embeddable languages, and xml-based languages. Memory 604 may also be used for storing temporary variable or other intermediate information during execution of instructions to be executed by processor 602.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 600 further includes a data storage device 606 such as a magnetic disk or optical disk, coupled to bus 608 for storing information and instructions. Computer system 600 may be coupled via input/output module 610 to various devices. The input/output module 610 can be any input/output module. Example input/output modules 610 include data ports such as USB ports. The input/output module 610 is configured to connect to a communications module 612. Example communications modules 612 (e.g., NICs 116, 140, and 192) include networking interface cards, such as Ethernet cards and modems. In certain aspects, the input/output module 610 is configured to connect to a plurality of devices, such as an input device 614 and/or an output device 616. Example input devices 614 include a keyboard and a pointing device, e.g., a mouse or a trackball, by which a user can provide input to the computer system 600. Other kinds of input devices 614 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback; and input from the user can be received in any form, including acoustic, speech, tactile, or brain wave input. Example output devices 616 include display devices, such as a LED (light emitting diode), CRT (cathode ray tube), or LCD (liquid crystal display) screen, for displaying information to the user.

According to one aspect of the present disclosure, the server 104, partner server 160, affiliate server 170, other insurer server 180, marketplace server 190, and client devices 102_1 . . . 102_N can be implemented using a computer system 600 in response to processor 602 executing one or more sequences of one or more instructions contained in memory 604. Such instructions may be read into memory 604 from another machine-readable medium, such as data storage device 606. Execution of the sequences of instructions contained in main memory 604 causes processor 602 to perform the process steps described herein. One or more processors in a multi-processing arrangement may also be employed to execute the sequences of instructions contained in memory 604. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network (e.g., network 106) can include, for example, any one or more of a personal area network (PAN), a local area network (LAN), a campus area network (CAN), a metropolitan area network (MAN), a wide area network (WAN), a broadband network (BBN), the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computing system 600 can include clients and servers. A client and server are generally remote from each other and typically interact through a communication network. The relationship of client and server arises by virtue of computer programs running on the respective computers and having a client-server relationship to each other. Computer system 600 can be, for example, and without limitation, a desktop computer, laptop computer, or tablet computer. Computer system 600 can also be embedded in another device, for example, and without limitation, a mobile telephone, a personal digital assistant (PDA), a mobile audio player, a Global Positioning System (GPS) receiver, a video game console, and/or a television set top box.

The term “machine-readable storage medium” or “computer readable medium” as used herein refers to any medium or media that participates in providing instructions or data to processor 602 for execution. Such a medium may take many forms, including, but not limited to, non-volatile media, volatile media, and transmission media. Non-volatile media include, for example, optical disks, magnetic disks, or flash memory, such as data storage device 606. Volatile media include dynamic memory, such as memory 604. Transmission media include coaxial cables, copper wire, and fiber optics, including the wires that comprise bus 608. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the term “include.” “have,” or the like is used in the description or the claims, such term is intended to be inclusive in a manner similar to the term “comprise” as “comprise” is interpreted when employed as a transitional word in a claim. A reference to an element in the singular is not intended to mean “one and only one” unless specifically stated, but rather “one or more.” The term “some” refers to one or more. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

1. A system for identifying insurance product offerings from different insurers to present to a user, the system comprising:
a memory comprising instructions; and
a processor configured to:
receive, over a network, user information from a referring insurer for a user seeking an insurance product offering, the user associated with a customer value prediction indicative of the user's likelihood to purchase an insurance product offering from the referring insurer;
when the customer value prediction is less than a threshold value, request a bid from at least two of a plurality of insurers for an opportunity to display an insurance product offering to the user;
receive the bid for at least one insurance product offering from each of the at least two of the plurality of insurers;
identify, based on the user information and from the bidding information, a qualifying bid for at least one insurance product offering from among the received bids for display in a prioritized insurance policy presentation on a website or in an application;
provide information indicative of the at least one insurance product offering associated with the qualifying bid for display in the prioritized insurance policy presentation on the website or in the application; and
provide information indicative of a user interaction with the prioritized insurance policy presentation on the website or in the application, to an insurer associated with the qualifying bid, wherein the user interaction comprises whether the user selected the at least one insurance product offering associated with the qualifying bid.

2. The system of claim 1, wherein the memory also comprises bidding information from the plurality of insurers for the received bids, and wherein the processor being configured to identify the qualifying bid for the at least one insurance product offering comprises the processor being configured to identify the qualifying bid for the at least one insurance product offering from the bidding information in the memory.

3-4. (canceled)

5. The system of claim 1, wherein the user for the insurance product offering is identified from the referring insurer, and wherein the prioritized insurance policy presentation on the website or in the application comprises an insurance product offering from the referring insurer and the insurance product offering from the at least one of the plurality of insurers associated with the qualifying bid.

6. The system of claim 1, wherein the prioritized insurance policy presentation on the website or in the application is provided for display on at least one of a web page, email, mobile application, or advertisement associated with the referring insurer, and wherein the processor is further configured to facilitate a payment, from the at least one of the plurality of insurers associated with the qualifying bid to the referring insurer, for providing the information indicative of the at least one insurance product offering associated with the qualifying bid for display in the prioritized insurance policy presentation on the website or in the application.

7. The system of claim 1, wherein the qualifying bid is selected based on at least one of a relevance of a bid to the user or an expected value to the referring insurer.

8. The system of claim 1,
wherein the user information comprises at least one of a zip code, credit tier, premium amount, geographic location, a reason for seeking insurance, a number of items to be insured, a previous insurer, education level, age, bodily injury limit, age of an item, number of previous insurable incidents, coverage package, type of residence, marital status, day of week an insurance product offering was requested, prior insurance information, amount of time lapse since the insurance product offering was requested, a number of drivers to be insured, or gender,
wherein the processor being configured to request the bid from at least two of the plurality of insurers for the opportunity to display the insurance product offering to the user comprises the processor being configured to provide the user information to each of the at least two of the plurality of insurers and
wherein each of the received bids is based on the provided user information.

9. The system of claim 1,
wherein the processor being configured to identify the qualifying bid for at least one insurance product offering from among the received bids comprises the processor being configured to identify at least two qualifying bids, each of the at least two qualifying bids associated with an insurance product offering provided by a different insurer, and
wherein each of the insurance product offerings associated with the at least two qualifying bids is prioritized for display in the prioritized insurance policy presentation on the website or in the application based on at least one of a value of the associated qualifying bid, a predicted relevance of the at least one insurance product offering associated with the qualifying bid to the user, an expected profit associated with the qualifying bid for the referring insurer, or the user information for the user.

10. The system of claim 1, wherein the processor is further configured to:
provide the information indicative of the interaction of the user with the prioritized insurance presentation on the website or in the application.

11. The system of claim 1, wherein the user information comprises at least one of a zip code, credit tier, premium amount, geographic location, a reason for seeking insurance, a number of items to be insured, a previous insurer, education level, age, bodily injury limit, age of an item, number of previous insurable incidents, coverage package, type of residence, marital status, day of week an insurance product offering was requested, prior insurance information, amount of time lapse since the insurance product offering was requested, a number of drivers to be insured, or gender.

12. The system of claim 1, wherein the processor is further configured to select the prioritized insurance policy presentation on the website or in the application based on the customer value prediction.

13. A method for identifying insurance product offerings from different insurers to present to a user, the method comprising:
receiving, over a network, user information from a referring insurer for a user seeking an insurance product offering, the user associated with a customer value prediction indicative of the user's likelihood to purchase an insurance product offering from the referring insurer;
when the customer value prediction is less than a threshold value, requesting a bid from at least two of a plurality of insurers for an opportunity to display an insurance product offering to the user;
receiving the bid for at least one insurance product offering from each of the at least two of the plurality of insurers;
identifying, based on the user information, and from the bidding information, a qualifying bid for at least one insurance product offering from among the received bids for display in a prioritized insurance policy presentation on a website or in an application; and
providing information indicative of the at least one insurance product offering associated with the qualifying bid for display in the prioritized insurance policy presentation on the website or in the application; and
providing information indicative of a user interaction with the prioritized insurance policy presentation on a website or in the application, to an insurer associated with the qualifying bid, wherein the user interaction comprises whether the user selected the at least one insurance product offering associated with the qualifying bid.

14. The method of claim 13, wherein identifying the qualifying bid for the at least one insurance product offering comprises identifying, from bidding information associated with the received bids stored in a memory, the qualifying bid for the at least one insurance product offering.

15-16. (canceled)

17. The method of claim 13, wherein the user for the insurance product offering is identified from the referring insurer, and wherein the prioritized insurance policy presentation on the website or in the application comprises an insurance product offering from the referring insurer and the insurance product offering from the at least one of the plurality of insurers associated with the qualifying bid.

18. The method of claim 13, wherein the prioritized insurance policy presentation on the website or in the application is provided for display on at least one of a web page, email, mobile application, or advertisement associated with the referring insurer, and the method further comprises facilitating a payment, from the at least one of the plurality of insurers associated with the qualifying bid to the referring insurer, for providing the information indicative of the at least one insurance product offering associated with the qualifying bid for display in the prioritized insurance policy presentation on the website or in the application.

19. The method of claim 13, wherein the qualifying bid is selected based on at least one of a relevance of a bid to the user an expected profit to the referring insurer.

20. The method of claim 13, wherein:
the user information comprises at least one of a zip code, credit tier, premium amount, geographic location, a reason for seeking insurance, a number of items to be insured, a previous insurer, education level, age, bodily injury limit, age of an item, number of previous insurable incidents, coverage package, type of residence, marital status, day of week an insurance product offering was requested, prior insurance information, amount of time lapse since the insurance product offering was requested, a number of drivers to be insured, or gender,
requesting the bid from at least two of the plurality of insurers for the opportunity to display the insurance product offering to the user comprises providing the user information to each of the at least two of the plurality of insurers, and
wherein each of the received bids is based on the provided user information.

21. The method of claim 13, wherein:
identifying the qualifying bid for at least one insurance product offering from among the received bids comprises identifying at least two qualifying bids, each of the at least two qualifying bids associated with an insurance product offering, and
each of the insurance product offerings associated with the at least two qualifying bids is prioritized for display in the prioritized insurance policy presentation on the website or in the application based on at least one of a value of the associated qualifying bid, a predicted relevance of the at least one insurance product offering associated with the qualifying bid to the user, an expected profit associated with the qualifying bid for the referring insurer, or the user information for the user.

22. The method of claim 13, further comprising:
receiving information indicative of an interaction of the user with the prioritized insurance policy presentation on the website or in the application comprising the identification of the at least one insurance product offering associated with the qualifying bid; and
providing the information indicative of the interaction of the user with the prioritized insurance policy presentation to the at least one of the plurality of insurers associated with the at least one qualifying bid.

23. The method of claim 13, wherein the user information comprises at least one of a zip code, credit tier, premium amount, geographic location, a reason for seeking insurance, a number of items to be insured, a previous insurer, education level, age, bodily injury limit, age of an item, number of previous insurable incidents, coverage package, type of residence, marital status, day of week an insurance product offering was requested, prior insurance information, amount of time lapse since the insurance product offering was requested, a number of drivers to be insured, or gender.

24. The method of claim 13, wherein the information indicative of the at least one insurance product offering is provided for display in the prioritized insurance policy presentation on the website or in the application when the customer value prediction is less than a threshold value.

25. A machine-readable storage medium comprising machine-readable instructions for causing a processor to execute a method for identifying insurance product offerings from different insurers to present to a user, the method comprising:
receiving, over a network, user information from a referring insurer for a user seeking an insurance product offering, the user associated with a customer value prediction indicative of the user's likelihood to purchase an insurance product offering from the referring insurer;
when the customer value prediction is less than a threshold value, requesting a bid from at least two of a plurality of insurers for an opportunity to display an insurance product offering to the user;
receiving the bid for at least one insurance product offering from each of the at least two of the plurality of insurers;
identifying, based on the user information, and from the bidding information, a qualifying bid for at least one insurance product offering from among the received bids for display in a prioritized insurance policy presentation on a website or in an application;
providing information indicative of the at least one insurance product offering associated with the qualifying bid for display in the prioritized insurance policy presentation on the website or in the application; and
providing information indicative of the user interaction with the prioritized insurance policy presentation on the website or in the application, to an insurer associated with the qualifying bid, wherein the user interaction comprises whether the user selected the at least one insurance product offering associated with the qualifying bid.

26. The system of claim 1, wherein the at least one insurance product offering associated with the qualifying bid is prioritized for display in the prioritized insurance policy presentation on the website or in the application based on the customer value prediction.

27. The system of claim 1, wherein the customer value prediction is determined based on at least one of a stored successful information for another user or a stored unsuccessful information for another user.

28. The system of claim 1, wherein the customer value prediction is determined based on a referral source indicator.

29. A system for identifying insurance product offerings from different insurers to present to a user, the system comprising:
(a) a computer memory comprising user information for a user seeking an insurance product offering,
(i) wherein the user information is received from a referring insurer at a website or application, and
(ii) wherein the user is associated with a customer value prediction indicative of the user's likelihood to purchase an insurance product offering from the referring insurer, and
(b) a marketplace server, which is coupled to the computer memory and comprises a processor configured to:
(i) receive the user information;
(ii) request a bid from at least two of a plurality of insurers for an opportunity to display an insurance product offering to the user when the customer value prediction is less than a threshold value;
(iii) receive the bid for at least one insurance product offering from each of the at least two of the plurality of insurers;
(iv) identify, based on the user information and from the bidding information, a qualifying bid for at least one insurance product offering from among the received bids for display in a prioritized insurance policy presentation on a website or in an application;
(v) provide information indicative of the at least one insurance product offering associated with the qualifying bid for display in the prioritized insurance policy presentation on the website or in the application; and
(vi) provide information indicative of the user interaction with the prioritized insurance policy presentation on the website or in the application, to the insurer associated with the qualifying bid, wherein the user interaction comprises whether the user selected the at least one insurance product offering associated with the qualifying bid.
